(19) United States
(12) Patent Application Publication
(10) Pub. No.: US 2007/0282959 A1
(43) Pub. Date: Dec. 6, 2007

(54) MESSAGE PUSH WITH PULL OF INFORMATION TO A COMMUNICATIONS COMPUTING DEVICE

(76) Inventor: Donald S. Stern, Lexington, KY (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/739,639

(22) Filed: Apr. 24, 2007

Related U.S. Application Data
(60) Provisional application No. 60/810,769, filed on Jun. 2, 2006.

(51) Int. Cl. G06F 15/16

(52) U.S. Cl. 709/206

(57) ABSTRACT

An alert system and method are provided in which a message is used to send an alert to the communications computing device and an application on the communications computing device can retrieve information/data based on the message.

### CROSS-REFERENCE TO RELATED APPLICATIONS

This application claims the benefit of U.S. provisional application Ser. No. 60/810,769, entitled “MESSAGE PUSH WITH PULL OF INFORMATION TO A COMMUNICATION COMPUTING DEVICE”, filed on Jun. 2, 2006 which is incorporated by reference in its entirety. This application is one of a set of related U.S. applications, the set including: METHOD AND SYSTEM FOR LINKING TO CONTENT AND SERVICES FOR A COMMUNICATION DEVICE (Atty. Docket No. GHACK19.001AUS, filed on even date herewith); and FORMATTING AND COMPRESSION OF CONTENT DATA (Atty. Docket No. GHACK19.002AUS, filed on even date herewith) all of which are incorporated by reference in their entirety.

### BACKGROUND OF THE INVENTION

1. Field of the Invention

The invention relates generally to a communications system and in particular to a system for providing rich content to a communications computing device.

2. Description of the Related Art

Sending a message to a device like a cellular phone is well known and is now being used by most users. It is known to send a text message for event updates in the cellular mobile phone market, however, the content of these message is at best 160 text characters, therefore limiting what can be sent using an SMS message. With the Internet consumers have become accustomed to email and other content rich data messages received on their desktop computers. Similar quality of content is currently not readily or cost effectively available via mobile cellular devices such as phones and PDA style devices. For example the SMS format is too restrictive for forwarding an e-mail to a mobile phone, the TO and FROM headers of an e-mail can easily be longer that 160 characters.

Many current model mobile phones today support high speed data internet protocol (IP) connections and contain software that format graphical menus that can display graphics, photo graphics, animation, different fonts, dozen of colors and many other display formats. The IP interface of the cellular phone uses a different communication protocol interface which allows for more content rich data to be sent and received by the phone. However to avoid the problem of mobile phone users being send unsolicited information using the IP interface, for example unwanted data and information such as viruses and advertisements being loaded onto the phone, cellular network carriers have limited the access to the IP interface so that a user must browse for content using special tools on their mobile phone to acquire such content or otherwise pull the content to the phone by polling a special client server.

It is desirable to enable content rich data to be delivered to mobile or other communication computing device in a user friendly and secure manner.

### SUMMARY OF THE INVENTION

According to one aspect, there is provided a system enabling a user's communication computing device to automatically acquire data from an authorized content provider via a communication network when an event occurs, the system comprising:

a validator adapted to receive information regarding an event occurrence from a source and validate whether the source of the event is an authorized content provider; and

an event message generator that generates an event alert message to be delivered to a user's communication computing device via the communication network that will enable a communication session to be opened by the communication computing device between the communication computing device and the authorized content provider for acquisition of content data associated with the validated event via the communication network.

According to another aspect, there is provided a method of delivering event content from a content source authorized by a user to a communication computing device communication computing device via a communication network when an event occurs, the method comprising the steps of:

receiving information regarding the occurrence of an event;

validating whether or not the event is an event from an authorized source for a user;

generating an event alert message for a validated event;

delivering the event alert messages to a subscriber's communication computing device; and

opening, by the communication computing device, a communication session between the communication computing device and the content provider for the acquisition of content data associated with the validated event based on the event alert and content source information messages.

Another aspect provides a system including a validator adapted to receive information regarding an event occurrence from a source and validate whether the source of the event is an authorized content provider, and an event message generator configured to generate an event alert message to be delivered to a user's communication computing device via a communication network that will enable a communication session to be opened by the communication computing device between the communication computing device and an authorized content provider for acquisition of content data associated with the validated event via the communication network.

Another aspect provides a method including receiving information regarding occurrence of an event, validating whether or not the event is an event from an authorized content source for a user, generating an event alert message for a validated event, delivering the event alert messages to a communication computing device of the user, and opening a communication session between the communication computing device and the content source for the acquisition of content data associated with the validated event based on the event alert message.

Another aspect provides a system including means for receiving information regarding occurrence of an event, means for validating whether or not the event is an event from an authorized content source for a user, means for generating an event alert message for a validated event, means for delivering the event alert messages to a communication computing device of the user, and means for opening a communication session between the communication computing device and the content source for the acquisition of content data associated with the validated event based on the event alert message.

Another aspect provides a computer readable medium comprising programming instructions that upon executing cause a machine to receive information regarding occurrence of an event, validate whether or not the event is an event from an authorized source for a user, generate an event alert message for a validated event, deliver the event alert messages to a communication computing device of the user, and open a communication session between the communication computing device and the content source for the acquisition of content data associated with the validated event based on the event alert message.

Another aspect provides a method including receiving a wireless messaging service message via a network, and in response to receiving the wireless messaging service message, retrieving via the network at least a data structure from a predesignated location, the data structure identifying at least one electronic device. The method further includes retrieving data from the identified electronic device.

Another aspect provides a system including means for receiving a wireless messaging service message via a network, and in response to receiving the wireless messaging service message, means for retrieving via the network at least a data structure from a predesignated location, the data structure identifying at least one electronic device. The system further includes means for retrieving data from the identified electronic device.

Another aspect provides a system including a communication computing device configured to receiving a wireless messaging service message via a network, and in response to receiving the wireless messaging service message, retrieve via the network at least a data structure from a predesignated location, the data structure identifying at least one electronic device, and retrieve data from the identified electronic device.

Another aspect provides a computer readable medium comprising programming instructions that upon executing cause a machine to receive a wireless messaging service message via a network, in response to receiving the wireless messaging service message, retrieve via the network at least a data structure from a predesignated location, the data structure identifying at least one electronic device, and retrieve data from the identified electronic device.

Another aspect provides a method including receiving a messaging service control message via a network, and in response to receiving the messaging service control message, retrieving via the network at least a data structure from a predesignated location.

Another aspect provides an electronic device configured to receive a messaging service control message via a network, and in response to receiving the messaging service control message, retrieve via the network at least a data structure from a predesignated location.

Another aspect provides an electronic device including means for receiving a messaging service control message via a network, and in response to receiving the messaging service control message, means for retrieving via the network at least a data structure from a predesignated location.

Another aspect provides a computer readable medium comprising programming instructions that upon executing cause a machine to receive a messaging service control message via a network, and in response to receiving the messaging service control message, retrieve via the network at least a data structure from a predesignated location.

Advantages of embodiments include enabling a communications computing device user to receive asynchronous event driven messages and access rich content associated with the event. Embodiments of provide a communications computing device implemented method for enabling content rich data to be automatically acquired by the communications computing device without device polling and/or without opening the phone to be addressed by a server. Thus enabling communications computing device users, such as cellular phone users, to be notified in real time of events like emails, news events, stock market events, scheduled events occurring and updates like the tracking of a person arriving on an airplane.

The gap between 160 characters of an SMS message and full graphically rich content display is caused by the process of getting this data to the communications computing device like cellular phones and smart personal data (PDA) devices. Embodiments utilize a real time notification such as text messaging to notify the communication computing device of the data availability then the data is acquired using internet server access functions like HTTP, XML, WAP and other protocols and formats for display. Therefore, a computer-implemented method of the type described herein allows for a server to contact a communications computing device, such as a cellular phone, enabling the device to connect to the server to download and render content data, so that to a user it is perceived that the data is pushed to the device.

In some embodiments, a standard text message (SMS) is used. In another embodiment a Premium text message (PSMS) is used which allows for the billing for the alerts sent to the user. The system may also use a multimedia (MMS) message sent to a communications computing device. These messages will in turn causes an application program on the communications computing device to establish a connection using GPRS and an Internet protocol (IP) like TCP/IP to fetch data that has been prepared for distribution to the communications computing device like a XML format or a WAP page which is download and displayed on the communications computing device.

The communications computing device can be any handheld or portable device which combines computing and networking functions. For example a communication computing device can be a cellular telephone (that operates on any cellular network), a personal digital assistant (PDA), a smart communications computing device, portable personal computer (PC), tablet computer, palm top device, handheld device, wireless email devices, wireless communication devices, such as the RIM Blackberry, wirelessly coupled computer systems (laptops, desktops, etc.), computer systems connected over a wired link, satellite devices that receive data over a satellite link or other device that combines a handheld or portable device combining computing and networking functions.

Content throughout this specification refers to information available as data from an electronic source and can include rich content such as available from an internet web site including graphically formatted textual information, images, animations, video and audio data. Content can also include information enabling accessing of further content such as links, URLs, or forwarding address information.

An event refers to any action which may be used to trigger the forwarding of content data to a user, such as when new content becomes available, time based events or triggering events, such as a calendar reminder or a periodic information update. Examples of events where information becomes available include breaking news, a score in a game, or receipt of an e-mail. Examples of time based events can include a periodic weather update or a calendar reminder. An example of a triggering event is a stock going below a $xx amount, when a desired product becomes available on an auction web site or when an airplane lands and is pulling up to a gate.

Throughout the following specification render and rendering is used to refer to the reproducing or displaying the content as the content provider intended to the content to be perceived by the user on the user's equipment. For example rendering the content includes but is not limited to reproduction of audio signals as sound output by device speakers, the display of visual images on a display screen and the display of animated content as moving images on the display screen.

### BRIEF DESCRIPTION OF THE FIGURES

FIG. 1 is a block diagram illustrating interaction between a user's device, a content provide and the system in accordance with an embodiment.

FIG. 2a illustrates a message sequence for sending an alert message and acquiring content data according to an embodiment.

FIG. 2b illustrates the process for sending an alert message according to an embodiment.

FIG. 3 is a functional block diagram of an embodiment.

FIG. 4a, b, and c illustrate the use of user profiles for formatting and downloading appropriate content versions in accordance with an embodiment.

FIG. 5 illustrates a hardware implementation of one embodiment of the system.

FIG. 6 is a flowchart illustrating the alert process of an embodiment and establishment of a communication session for content delivery.

FIG. 7 illustrates an embodiment of the registering of an application to ports of a mobile device for receiving alert messages.

FIG. 8 illustrates an embodiment of a user registering to receive alert messages.

### DETAILED DESCRIPTION OF THE INVENTION

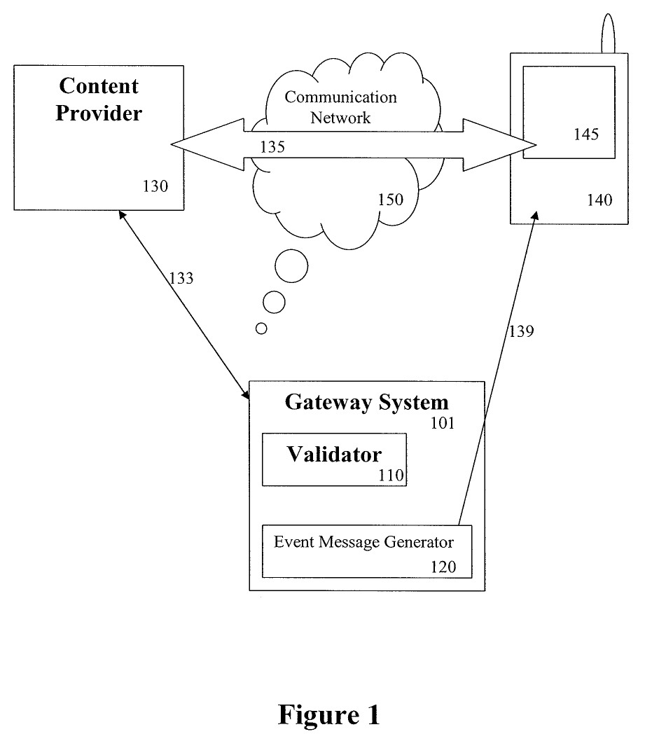

Embodiments provide a system (see an example system illustrated in FIG. 1) and method enabling a user's communication computing device 140 to automatically acquire data 135 from an authorized content provider 130 via a communication network 150 when an event occurs. The system 101 comprises a validator 110 and an event message generator 120. The validator 110 receives information regarding an event occurrence from a source 133, such as from a content provider 130, and validates whether the source of the event is an authorized source 130. The event message generator 120 then generates event alert and content source information messages to be delivered 139 to a user's communication computing device 140 via the communication network 150 when an event is validated as originating from an authorized source. The event alert and content source messages enable a communication session to be opened 135 by the communication computing device 140 between the communication computing device 140 and the content provider 130 for acquisition of content data 135 associated with the event via the communication network 150.

A user's communication computing device 140 can be adapted to automatically open a communication session 135 between the communication computing device 140 and the content source 130 on receipt of the event alert 139 and content source information messages, or the opening of the communication session can be triggered by an action of the user, for example pressing an “ANSWER” key on the communication computing device 140. An advantage of this system is that no or minimal interaction with the communication computing device 140 is required by the user to obtain the content associated with the event. Thus, to the perception of the user, the content is seamlessly “pushed” to their communication computing device 140 from the content provider when the event occurs.

As the user's communication computing device 140 opens the communication session to acquire the data from the content provider only once the source 130 has been validated by the validator 110 as an authorized source. Only content from sources the user has authorized will cause a message to be sent to the user's device to enable the content associated with the event to be delivered. Thus, the system 101 acts as a gatekeeper or mediator between content providers and the user's to avoid user's being inundated with event messages or content from unauthorized sources.

The content data can be compressed to enable speed and bandwidth efficient content acquisition. Further the content provider can prepare content in specific formats for downloading and display on particular types of communication computing devices.

In an embodiment a user's communications computing device is adapted for use with the system by installing a software application that is executed by a processing unit of a communications computing device. For example the user's communications computing device can be a cellular phone device or smart PDA device that supports both SMS/MMS and (GPRS) protocols. In this embodiment the SMS/MMS capability is utilized for receiving the event alert message, and the GPRS capability used for acquiring the event data.

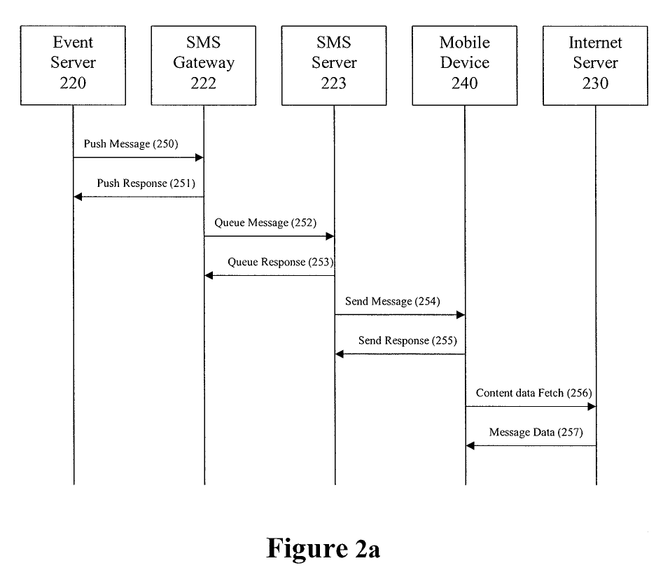

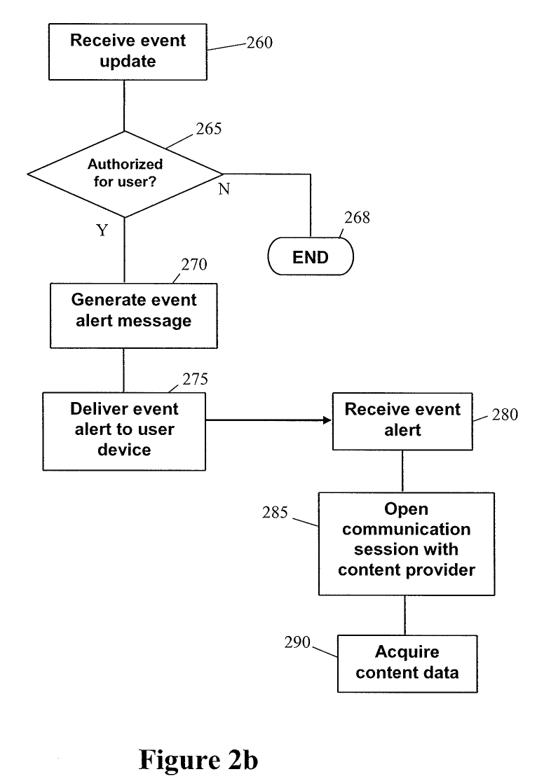

In such an embodiment an SMS or similar signaling, or messaging, which is delivered to a mobile phone by the communication network, can be used to alert the user of an event occurrence, and cause an application on the phone to automatically acquire and deliver the associated event data to the user. As shown in the message sequence of FIG. 2a and 2b, when an event occurs in an authorized content provider, information about the event is received 260 by the event message generator or is generated by the event message generator such as in a periodic update event. For example, an event could be the receipt of an email, from an internet email server or other types of event for which information is sent to the event message generator by the content provider such as a news release for a stock that the user has setup to be alerted for or any other activity/action for which a user might want to receive an alert. Where the event information is received from the content provider the event server can also verify 265 whether the content provider is registered to use the event message service and authorized by the user. If the content provide is not an authorized source, then no event alert message will be generated 268. Where the user has authorized event alerts from the content source, an event alert message will be generated 270 and sent 275 to the user's communications computing device. The user's device receives 280 the event alert message and based on this message opens a communication session 285 to the authorized content provider to acquire the content data 290.

In the example shown in FIG. 2a the event generator comprises an event server 220 and an SMS gateway server 222. The information regarding the event sent by the content provider is received by the event server 220. The event server 220 prepares a text message to be sent to the communications computing device 240. The text message is prepared to comply with a format which enables the message to be interpreted by the application program running on the communications computing device 240. Once this message has been prepared in the appropriate format by the event server 220 it is sent to the SMS Gateway Server 222. The message can be sent using one of many known interfaces. The example shown in FIG. 2 uses an API call such as Push Message 250 that causes a peer to peer connection or a client to server session to be established from the Event Server 220 to the SMS Gateway Server 222. Alternatively, the SMS Gateway Server 222 may be implemented as software installed and running as a task on the Event Server 220, and the API call would send a Push Message 250 queued message to another task in the same server.

The SMS Gateway Server 222 can verify the user account, for example using a cellular phone number or other account information that would identify the communications computing device 240. As user is verified it can also be confirmed whether the content provider is an authorized content provider for the user, for example by checking a list of authorized content providers in the user's account. This step may not be necessary in some instances, such as where the event is a periodic update event triggered by the event message generator. The SMS Gateway Server 222 may also cause a billing event for the message service, for example to bill for sending the message or confirm that a user's subscription to the message service is current and access has not been prohibited due to unpaid bills. Other types of billing may also be included in this processing step.

Once a user's account is verified, the SMS Gateway Server 222 sends the message to the SMS server 223 for forwarding on to the user's mobile device 240. The SMS Gateway Server may either send the message to the SMS Server 223 to be put in a delivery queue before responding to the Event Server 220 or may reply to the Event Server 220 that the user account information is valid and then decide how to cause the message to be sent to the SMS Server 223.

In the embodiment shown in FIG. 2, the SMS Gateway Server 222 responds with a Push Response 251 call return, after the account information is verified to allow the Event Server 220 to be released, so that it can handle other events that may need to be formatted and sent, before forwarding the message to the SMS server 223. The SMS Gateway Server 222 can then interact with the SMS Server 223 to Queue the Message 252 and for the SMS server to send to the communications computing device 240.

Once the SMS Server 223 has queued the message for forwarding to the user's communications computing device 240, the SMS server may send verification that the message is queued to the SMS Gateway server 222, for example by responding with a Queue response 253.

A response can also be sent back from the SMS Gateway Server 222 to the Event Server 220, for example to confirm the message is sent to the user or in the case of an error, for example including a status or error code that indicates the message was lost and needs to be resent, or that a SMS Server 223 is down or not responding and the message has been queued to be deliver at a later time. Other status or error codes could indicate that the user account has been disabled by the network carrier, that the user message queue is full or any other types of error or status which is applicable. An error code may be returned immediately or at a later time depending on when the error occurs. The system can take appropriate corrective action based on the error code, for example, re-sending the event alert message, queuing the event alert message to be sent at a later time or aborting the event alert and content delivery.

The SMS Server 223 sends the message 254 to the communications computing device 240. The communications computing device 240 passes the message to an application, running on the communications computing device or launched in response to the receipt of the SMS message 254.

An embodiment uses GSM Short Message Peer to Peer (SMPP) protocol specifications for the event message. This protocol provides an External Short Message Entities (ESME) interface which allows additional data fields to be added to the user data header (UDH) of an SMS message. This ESME (External Short Message Entities) interface is normally not used in standard SMS message encoding. This ESME interface is typically used by routing entities when SMS messages are routed between servers. However, because the ESME interface it is part of the SMS standard and is used for other internal system functions then the basic protocol is included in most SMS software implementations. An advantage of the special SMS messages using the ESME interface is that as this functionality is typically used for routing between SMS servers, any messages having this header are given priority over standard SMS messages in the SMS server queue. Thus these special SMS messages are not subject to the usual first in first out (FIFO) queue handling of a typical SMS store and forward server queue, and are forwarded by the SMS server before standard SMS messages in the queue. This embodiment uses these special SMS messages for alert messages to avoid delays caused by SMS server queues. Further, using the special SMS message enables an embodiment to be implemented where all the information enabling the application running on the user's device to respond to the alert message to access the content can be included in the UDH of the special SMS message, and thus the SMS message contain no data in the message body, which can further speed up the delivery of the alert message.

The Special SMS message UDH header includes the following fields:

Destaddr: This is the destination address or phone number of the users mobile device.

Message: This is the message content that is used in a standard SMS message.

Scheduled: This is an additional parameter that allows for the scheduling of a message to occur which would override the standard FIFO (first in first out) queuing that occurs in most SMS systems.

Validity: This is a message life field and tells the SMS system how long to allow the message to be kept in a queue before it should be erased or has expired.

Srcaddr: This is the address of the SMS server that sent the message. This can be used to authorize the sender of security checking.

Destport: This is a destination port address of an application or other pointer to a system function that is to receive the message. This allows a special message to be routed around the normal SMS message system software.

Dcs: This field describes the type of data format encoding that the message has been encoded in.

Pid: This is a protocol ID value that indicates which kind of special protocol options have been selected. Some of these options can require the receiving device to reply that it received the message.

Key: This is a security key field that the sending application and the receiving application have agreed upon as to how the message data has been encrypted.

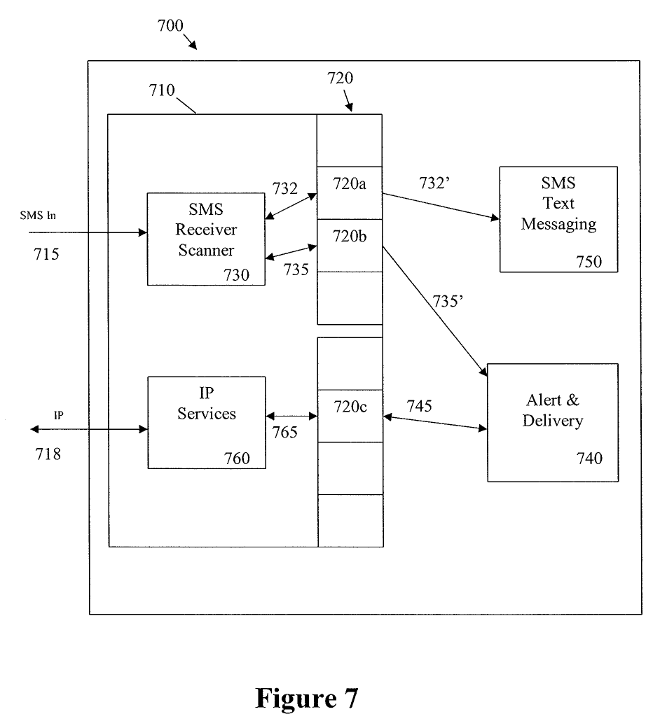

The alert and delivery system uses an SMS message sent to the communications computing device in order to cause some action to occur at the communications computing device, such as the downloading of data. In an embodiment, the system uses a special SMS message as described above where the “Destport” field of the message identifies the message as an alert message and activates the alert message handling on the user's device. In this embodiment, as illustrated in FIG. 7, each communications computing device 700 has ports 720 defined in its transceiver subsystem 710 which can be addressed as destination ports and the application is a piece of software on the communications computing device 740 bound to a particular destination port 720b as a receiver of data addressed to that port. For example, a port can be bound using the SMPP bound_RX functions. A destination port address can be contained in the User Data Header (UDH) of a Short Message Peer to Peer protocol (SMPP) or SMS or text message. The header of incoming messages 715 are scanned 730 to determine whether the message is a regular message, such as an SMS text message which will be passed 732 to the port 720a for passing 732′ to SMS text message processing 750, or whether the message is addressed to the port 720b bound to the application 740, such that the message will be passed 735 to the bound port 720b to be received 735′ and processed by the application 740.

In this embodiment, the UDH header of an event generated message contains a destination port address of the particular port 720b that the communications computing device has bound the application 740 to as a receiver. Thus, when a message 715 is received by the communications computing device with the particular port 720b information in the address, the application 740 on the communications computing device registered to that port 720b can be activated without the user of the communications computing device being aware of the SMS message. The SMS message 715 can actually cause the application 740 registered to the port to be launched or started and then the application can perform the action, such as retrieving a web page from a URL, etc. based on the received message. Not having the application program running all the time but only when it is communicating or displaying content conserves battery power, unlike a client, where part of a client server system is always running on the mobile device.

The software 740 that runs on the communications computing device 240 can be started during the device initializing or booting to register the application to a port 720b. Alternatively, the communications computing device 240 user can select and start the application. During the software initialization of the software application program on a communications computing device 240 a call is made to the operation system using an application programming interface (API) that causes the software program to set up an entry point to cause the application to be launched when a message registered to the port is received. After registration to a port the application closes so it does not run as a background process on the device to conserve power. When a message is received the communication computing device operating system calls a program application that receives incoming data packages 730 to scan the incoming data package and look for a SMS message with a special destination or source port address. This data package scanning function can be a standard device operating system function which routinely directs data packages to ports registered for receiving programs, such as SMS, MMS, or IP receiving programs registered to the ports during initialization, where the receiving program, and hence receiving port, is identified based on information included in the package header. The packet scanning function 730 monitors incoming data that is received by the communications computing device 240 and will identify and reroute incoming data packets to the application program 740 that has registered for the port 720b. The program application 740, registered for the special destination port address, receives the SMS message. The SMS message is thus redirected to the application program 740 instead of going the text message program 750. Methods other than registering a program as a receiver for a port are contemplated within scope. For example, if SMS is used for the event alert message format, the SMS handling functionality may be adapted to read the SMS header and divert alert messages to an alert message handler.

During initialization, when the device is turned on or booted, the application program 740 may register for the input port 720b and then end its execution, which requires that the operating system to start, restart or reload the application program 740 and route or queue the received data package to the application program 740 each time a message is received. Alternatively the application program 730 740 may start up during initialization and remain running, scanning each message as it is received. Once the application, which is registered for the destination address in the SMS header, receives the event message the application can send a response message 255 verifying that the message 254 has been received. In some cases this may not be necessary depending on the system implementation. Alternatively where the SMS server and content sever are implemented in the same hardware, for example if the fetched content is the content address list data and content list and the SMS server are implemented as two functions in the same server, when the content data is fetched then this can also be in indicator to the system the message was received.

Once the application has been contacted and is running then the application scans the formatted content of the message. The message 254 can contain information to display or it may contain location information, in a form such as a URL, a record locator ID number or any other format that has been designed, in the data field. Alternatively the message may contain no data in the message data field and comprise only a message header, in this embodiment the application can then look up location information in device memory for a known source from which further information can be obtained. For example in this embodiment the application may be designed to go to a special server or other location in the data network to fetch a list of content that is pending to be displayed. This list may be kept on a secure server that is only accessed though the gateway server during the authorization step or have a key that is received from the authorization step that is used to access the content or list of content to be displayed.

The content location information enables the application to open a communication session between the communications computing device 240 and the content source such as Internet Server 250 for the transfer of content data 257 to the Communications computing device 240 in one of many standard formats understood by the communications computing device 240 for example a WAP page for a Cellular phone, or a XML formatted menu that can be displayed by a Smart Phone or PDA device. After the data is acquired by the user device the communication session can be automatically closed by the user device 240 to minimize the risk of any undesirable communication via the communication session, such as viruses or unsolicited content. Thus the communication session is only opened to a specific content provider, to download specific content, and only for the time necessary for the data transfer to be completed.

For example, if the application program 740 is already running or is a background task it will receive the data package from the scanning function 730 in the input subsystem 710 which receives the event message. The application 740 then gets access to the content data associated with the event message by using data in the message body to open a communication session 760 between the user's communications computing device 240 and the content provider 250. The communication session 760 can be a GPRS and IP communication session opened by the application 740 using the TCP/IP or UDP or any other data format functionality of the communication computing device 240. The communication session may use the same port 720b as addressed in the event message or an alternative port 720c. Where an alternative port 720c is used, the IP communication 718 is passed 765 to the port 720c by the IP services receiving function 760 of the input subsystem 710 for forwarding the data packets 745 to and from the alert and delivery application 740. As the content data source and location are known, from the data in the event message, the communication session can be targeted to the content server 250 and the address on the server for the event data. The data is then acquired using this communication session by using a pointer or calling an API to get access to one of many techniques used commonly by programmers for acquiring or downloading data. For example techniques for acquiring data such as shared memory, memory mapping of pages or segments or a pointer to the data area containing the content data can be used. All techniques known and used by programmers for data acquisition are contemplated within scope and encompassed within the scope of the claims which follow.

In one embodiment, once the application program has successfully opened a communication session and gained access to the content data, the application informs the user, for example using a audible tone or beep, playing a audio file (like “you got mail”), creating or adding a icon or other the indicator to the current screen or lighting up the screen to indicate to the user that a message has arrived that the user can take action on. The application may be adapted to automatically acquire the content to be rendered for the user on the communications computing device or the application may be adapted to provide notification to alert the user to the event occurrence and availability of content data and wait for the user's response before rendering the content. At which stage in the event message and content acquisition process the user is alerted to the event can be set or varied by the user as a preference either in the application running on their communication computing device or for their account. Many other items may be checked such as where the content will fit in the memory of the device and if not may inform the user that the user should clear some files, messages or take other actions to allow for the receipt of the content.

There are many alternative indicators the application can use to notify the user of the event and the presence of content data based on the user settings for notification, either for this type of message or generically. For example the alert can follow the users setup functions for their phone, such as to set silent, vibrate, ring, beep, or play special downloaded tones, songs, or other indicates commonly user by phone manufacturing to notify the user. This may also include notification through wired or wireless devices connected to the phone like wireless ear devices or other computer or PDA like devices that are wired or wireless. In an automotive connected device a flashing light or audible beep or tone may play on the radio or audio system installed in the automotive environment.

In an alternative embodiment the application can be adapted to interrupt other functions, such as a phone call that is currently in progress or a browser session the user is currently using, once the application program has received the message and a communication session with the content source is set up. This can be done by displaying a message or opening a window or display message on the screen of the phone and asking the user if they want to continue the process of getting the data/message/answer or other content. The phone user can delay until the current task is complete or to wait until the user request the content be retrieved and displayed by starting or switching to the application program and requesting that it fetch the content or data from a server. Where the task of content display and the current ongoing task can take place concurrently the user may request the content data as well continue the current task, for example where the user is making a voice telephone call using an ear piece remote from the device, such as a Bluetooth earpiece, so the user can also view the phone screen and the content is only visual information such as a news bulletin or weather update, the user may choose to continue the call and concurrently request the content data be displayed for them to view on the screen. Similarly the application may be capable of determining what tasks are currently ongoing when an event update occurs and determine whether or not to interrupt the task and alert the user based on user preferences. For example, do not interrupt telephone calls to alert the user of content availability but do interrupt browser sessions if an event occurs. Such preferences could be implemented using a user defined priority list, with telephone calls having the highest priority, say priority 1, browser sessions having a lower priority, say priority 3, and listening to music or viewing photos or video clips the lowest priority, say priority 5. The user can nominate at which priority level tasks the alert is to interrupt ongoing tasks, for example allowing only priority 5 tasks to be interrupted would mean the alert is delayed in the phone if the user is engaged in a telephone conversation or browser session until the user ends the call or session, however an alert will interrupt music or videos the user is listening to or watching. The priority can also be set up so that if an incoming voice call is received during the receipt and display of a alert message, then the alert and display process can be suspended to allow this higher priority task to occur and once the voice call is ended the alert and display process resumes.

If the user decides not to access the content data at the time of the alert message then the application can save or queue the content location information from the message in either volatile or non-volatile storage media so that this content location information can be accessed at a later time when the user wants the information. This storage can be either on the mobile device such as in device memory, a server such as the event server, another media such as a removable media, or another device such as the user's PC. This storage can also be used to keep several messages and allow the user to list, delete or access the content at any time they chose. The list of messages can be kept on the device or on a memory card (like flash or SIM cards) and may be moved to other devices and then accessed at a later time, for example moving the list to a PC and then retrieving this information during a PC-device synchronization process.

Where content data is available for download from more than one content provider or more than one location, the event message may contain a list of content data locations. Alternatively a list of content data locations for the user is stored in a content source list on an event system server and the user's device first connects to this server in response to the alert message to download one or more content data locations first. In this case the application can sequentially establish a communication, acquire the content data from the content source, and close the communication session for each content item. The communication sessions may be established in response to a user action, such as pressing a NEXT button to open the next communication session and acquire the next content data or a user may select the content to acquire from a list displayed on a device screen. Alternatively a separate event message may be used for each separate event, so the above steps will be executed to acquire content data individually for each event.

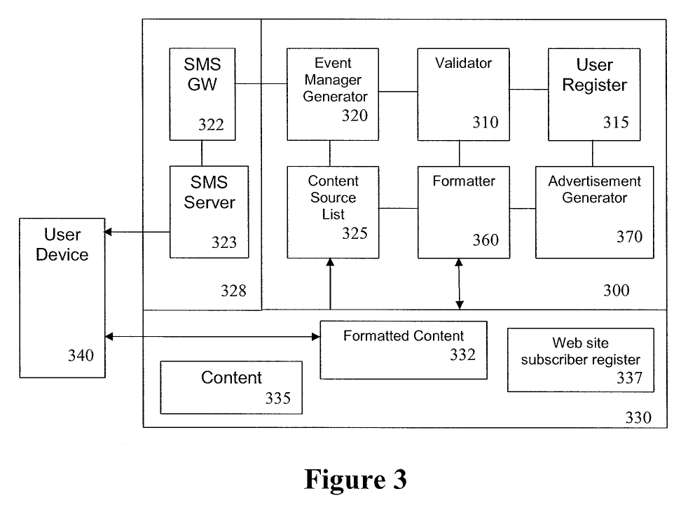

FIG. 3 is a functional block diagram of the system illustrating the interaction between the system and the content providers in more detail. The system 300 comprises validator 310, and event message generator 320. In the embodiment shown in FIG. 3 the message delivery functionality of an SMS gateway server 322 and SMS server 323 are implemented as part of the communication network 328. The system 300 further comprises a user register 315, content source list 325, formatter 360 and advertisement generator 370.

For this example the content provider 330 is an Internet web site residing on a Web server. The updating of the content 335 on the server triggers the server to send an event update to the event message generator 320. The event update includes information including: the content source, the location of the updated content 335, and information identifying the user's who have subscribed to the content provider to receive notification when the content is updated, for example from a web site subscriber register 337.

The location of the updated content 335, for example URL, web site address, or address to a server or database data storage facility and pointer to the content within the storage facility, is stored in the content source list 325.

The validator 310, in this embodiment, performs two separate checks. First the validator 310 checks whether the content source 330 has registered with the message service and second, whether the user to receive the event notification is also registered with the event alert service for the content provider 330 using information from the user register 315. Confirming the user is registered for the service also confirms that the user's device is adapted to use the event message service, for example, has had the appropriate applications installed on the phone to handle the event messages and content acquisition as described above. The user register 315 includes, for each user, a list of authorized content providers and the profile of the communications computing device, the user is identified by information forwarded in the event update, such as a phone number or e-mail address. The verification can be in the form of a data base look up using the user identification information from the content provider event update, the verification can check for several users and return several user identification items or profiles.

This embodiment of the system 300 further comprises a formatter 360 which can be used to re-format the content into a form optimized for each user's communications computing device based on the profile information obtained during verification. Due to the variety of possible devices and lack of standards in the mobile device market there are many different device attributes, for example screen size and format. The screen size in the current mobile device market has over 80 different screen sizes and pixel sizes. In the personal computer (PC) market there are only about 10 different screen sizes but most web sites design for two or three screen sizes and the software on the PC can reformat the data to be displayed appropriately. In mobile devices, where the screen sizes are typically smaller than PCs and the devices may have limited memory and processor capacity it is advantageous to optimize the content format before transferring the content to the mobile device.

The formatter 360 uses profile information for each user to process the content data 335 from the content provider 330 into a format appropriate for display on the mobile phone 340, for example for a phone with text only reproduction ability, any visual images or animations can be stripped out of the content so this data will not be transferred to the user device. The formatter 360 receives a device profile back from the validator 310 when the user is validated. This profile can then be used to reformat the data for the device before it is sent to the mobile device. Other items can also be profiled or configured like the keyboard layout on the mobile device and function or keyboard mapping can be done before being sent to the device to allow for easy use and similar function regardless of the content design. Other items like memory size on the user equipment can also be profiled so that the amount of content can be resized to allow for it to fit into the user memory. The formatter can also be used to appropriately concatenate content from a number of different sources, for example the content may include a home page with links to other content providers such as a weather information provider or a number of advertisers, the formatter can be programmed to acquire copies of the content or links to content from the other content providers and determine how the concatenated information is to be formatted, for example tiling options for advertising images at the bottom or side of the device screen based on the screen dimensions, or inserting a link to current weather information for diverting to the weather server to fetch a copy of the current information during data acquisition.

The re-formatted content is then stored back on the content provider's system in one of many places like memory of a file or a data base and the content source list 325 updated to reference the re-formatted content 332. Where several different re-formatted versions of the content exist, such as where there are several user's subscribed to the content all having different device profiles, the content source list 325 will contain the location information for the appropriately formatted content for each user, based on the user profiles. This can be a preformatted or static content that is stored in a format ready to be acquired by many users, or very dynamic content which changes often and irregularly. For example the Motorola V3 may be the largest selling and therefore the user equipment device having the highest probability of being used to access the content. Where the content is substantially static such as a weather report which does not change very often, maybe once a day a copy of the weather report pre-formatted for a number of devices may be automatically prepared and stored when the weather report is updated, regardless of whether there is as pending request for data updated via the event system or not, as it is likely that a request for the weather report in these data formats will be received before it is next updated, and formatted for a less popular device only on request. Alternatively, for very dynamic content such as a basket ball game currently being performed with photos of the player making the last shot may be preformatted only for the Motorola V3 as the most popular device and only formatted on request for a user device that is less popular. Alternatively all content may be dynamically formatted on request.

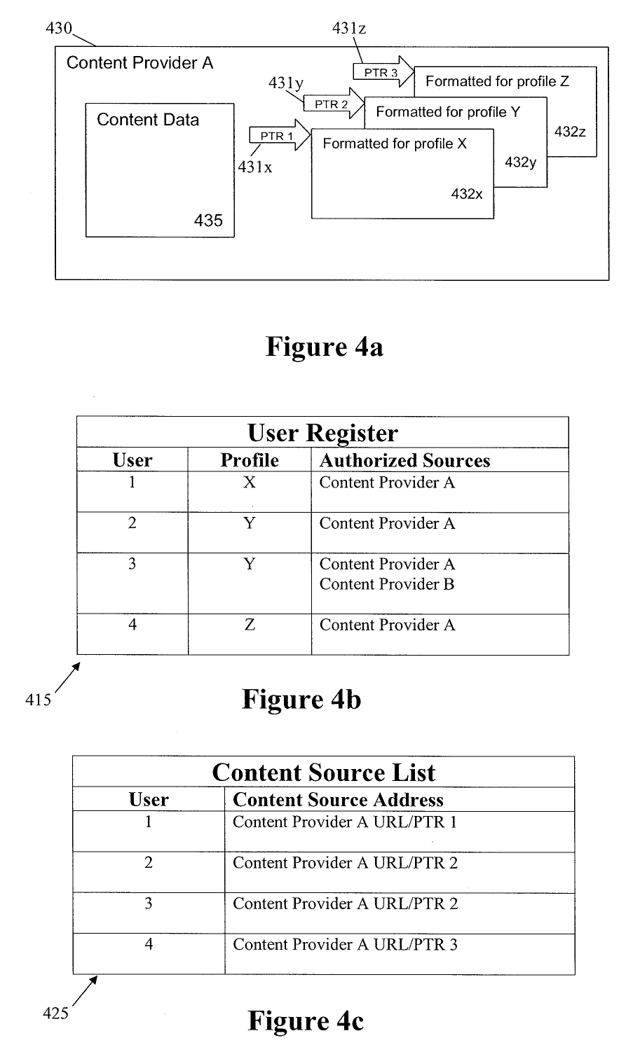

The formatter 360 functionality can be implemented in the event system as shown in FIG. 3, in this embodiment the formatter fetches the content data from the content server, performs the re-formatting based on the user profiles and sends the content back to the content server for storage and subsequent download to the user devices. Alternatively, the formatter functionality 360 can be provided to each content provider, for example as an application to run on their server. In this embodiment the required profile information is returned to the content server. For example as shown in FIGS. 4a to c, four users have subscribed to receive the content 435, users 2 and 3 both have profile Y and users 1 and 3 have profiles X and Z respectively recorded in the user register 415. After validation the content provider will be instructed that content formatted using profiles X, Y and Z is required. The re-formatting for these profiles is then performed by the formatter application on the content provider server 430. The re-formatted content 432x, 432y, 432z is then stored on the content server. The data can be stored or queued for transfer to the mobile device. The data can be sorted in a database system or a flat file or any number of server formats to make it available to the user's device for data acquisition by the device. Re-formatted content location information 431x, 431y, 431z for each version of the re-formatted content is returned to the system for updating the content source list 425. As is shown in FIG. 4c the content list 425 records the location for the content formatted for profile X for user 1, for profile Y for users 2 and 3, and for profile Z for user 4. An advantage of using the profiles in this manner is the content only needs to be formatted for the actual content users. Further by the content provider having control over the formatter application the content provider can have control over how the formatted content will appear when it is rendered for the user on their device, for example by adjusting the formatter settings or ability to preview re-formatted content. Formatted content can also be compressed to minimize the amount of date to be transferred to the user's device and hence minimize the time and cost for acquiring the content.

Once a content source is verified and any required formatting of content data is performed the event message generator 320 prepares an event alert message to be forwarded to the user's device as described above with reference to FIG. 2. In the embodiment shown in FIG. 3 the event message generator 320 sends the event alert message to the gateway server 322 for forwarding to the SMS server 323 for forwarding to the user's device 340 via the communication network 328. The alert message may be in a standard message format such as SMS or any other type of signaling message or communication event which will be received by the user device when sent by the system. Thus the event alert message is “pushed” by the system to the user's device, rather than the user needing to log into a browsing session or the device poll a server for any event updates.

The reception of the alert message by the user's device causes the users device to establish a connection to acquire the content data directly from the content provider 330. In one embodiment the alert message includes the content source information from the content source list for the user in the event alert message. In this embodiment the user's device 340 can use the destination address message to automatically open a communication session directly with the content provider 330 for downloading the content 335. Alternatively the address or location information of one or more content items may be sent in a second message and similarly this information be used to open a communication session to acquire the content data directly from the content provider server 330. Where a number of content items are available the user may be able to select which item to open from a displayed list.

Alternatively a pointer to the user's entry in the content source list 325, providing a list of location information for each content item available or queued for downloading from various sources for the user, can either be sent in the event source message or stored in the user's device memory. The user's device can then open a communication session between the user's device 340 and the content source list server to acquire the address information for one or more content items. Once the user has acquired the content source information the communication session can be closed and a communication session opened between the user's device 340 and the content source server 330. Once content is acquired from the content source server 330, the user's device can reconnect to the content list server again, either automatically to in response to a user action such as a button push, to obtain location information for the next item. The advantage of using the content source list is that only content items from authorized content sources will be included in the content source list. The user device obtains the content location information from a single known and trusted source thus providing a high level of security, and the validation of content sources means only allowed content should be transferred to the user's device. The content list can be kept on a separate server that is secure and will only allow access but mobile device that follow a special handshake or use a security code to gain access to the content list that is stored on it. This content list can be updated from many content sources that store content and pass a pointer to the content storage location to a central content pointer server.

The register 315 can also include information such as a demographic profile or log of system usage, which can be used for marketing purposes such as the addition of advertising to event messages or content but the advertising generator 370. The addition of advertising can have the beneficial effect of enabling advertising revenue to subsidizing the costs of providing the content and the alert service to the users.

Another function which can be monitored or information maintained as part of the user profile is user content profiling. This user content profiling can be used by the application to select what kind of content is appropriate if a filtering function is enabled and what kind of advertising can be used together with the content to be sent to the user. For example where the user is a minor, based on their age recorded in the profile, subscribing to a movie preview web site, violent or adult content previews may be prohibited by the filter. In another example, advertisements for certain food products may be prohibited for some users based on religious beliefs registered in the user profile, or based on the registered country or region and sensitivity to the predominant religion for that area. The content a user subscribes to or accesses through the system may also be monitored or logged to build demographic information to add to the user's profile, for example to be analyzed to create a user targeted advertising profile.

Location based information can also be profiled or included in the exchange between the content provider application software and the verification server where points of interest and special kinds of offers can be brought to the user attention as part of the content being sent. For example, if the user is in a restaurant eating and a weather update is being sent, then a coupon for that restaurant could be included in the weather content. If a sport score is updated and the user is in a mall then an advertisement for new sport shoes could be included in the sport score and if the local team is winning by 20 points a discount item offered while they are at the mall shopping.

The embodiment illustrated in FIG. 3 shows the formatter and advertising generator all provided as centralized functions of the event alert system, however these functions may be distributed to each content provider, for example to enable each content provider to re-format their own data and apply profile based advertising to the formatted content. The system may also be implemented where these functions are provided both centrally and distributed to some content providers, for example depending on the level of event alert service the content provider has subscribed to the content provider may not be provided with an advertising generator, so only centralized advertising can be appended to the content.

As discussed above an application can be provided to content providers to work with the system, for example an application can be provided to run on a content provider's server to inform the system when an event occurs for which data can be provided to a user. The application can further be adapted to prepare or convert the content in a format suitable for delivery to the communications computing device and store the formatted content on the content provider's server. Optionally this converted content can be optimized for a number of types of communications computing devices such that the appropriate optimized content can be automatically selected for download to the user based on a user profile or preference. The user profile or preference information can be stored by the content provider or forwarded to the content provider during the communication session setup and content acquisition process.

The application can be delivered to the content provider when the content provider registers to use the event alert and delivery system 300. For example, a web site designer of the content provider wishes to incorporate the alert and delivery services as an option for their users in relation to content updates, for example new catalogues released, sale information, spot score updates, forwarding e-mails to a mobile phone etc. The web site designer contact the alert and delivery service to register to use their system. The registration to use the alert and delivery includes recording the content provider site as a registered content provider and providing and installing the above applications on the web site server to adapt the site for use with the alert and delivery system. The registration can be fully automated, for example by providing an interactive web site registration facility, where one the terms and conditions for the event and delivery service are accepted and any payment made the appropriate applications are downloaded to the registered web site server.

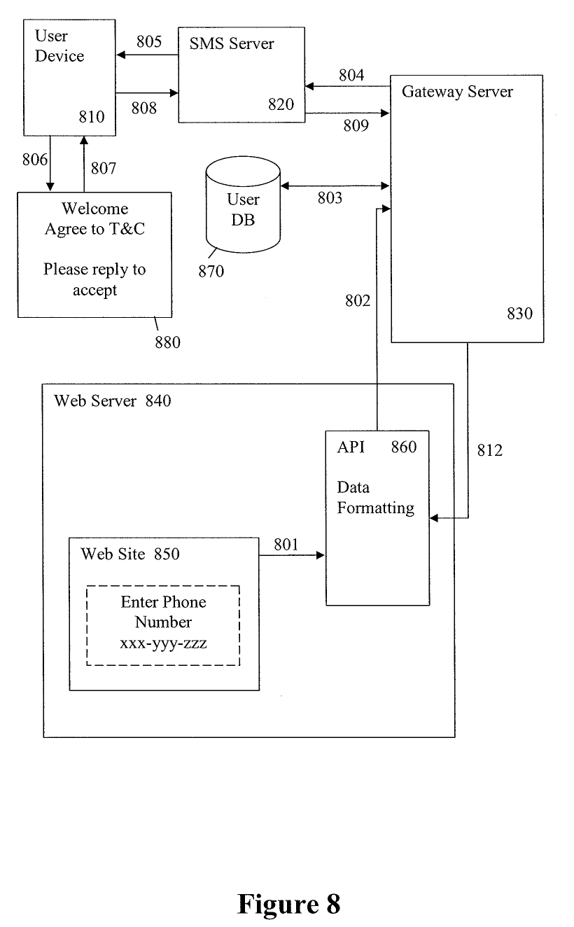

In some embodiments, a user registers with the alert and delivery system as part of the request to receive event messages from a content provider, such as subscribing to updates on a web site or requesting e-mails to be forwarded to the user's mobile phone using an option provided by the user's e-mail server, which in turn is registered with the event alert and delivery system. An example is illustrated in FIG. 8. For example, the user can go to a web site 850 or email site on a host server 840 or have an administrator register them for a alert service by entering the phone number of their mobile phone 810 and optionally an identifier (an ID such as an IMSI: International Mobile Subscriber Identifier, or an IMEI: International Mobile Equipment Identifier). Where no other identifier is given the phone number becomes the ID used to identify the user. The user's ID and phone number are sent to the event alert and delivery system gateway using an API register call function 801, provided by the event alert and delivery application 860 installed on the content provider's server 840. The register call function will format and make a registration call 802 to the event alert and delivery gateway server 830.

The event alert and delivery gateway system 830 will check 803 the user register data base 870 to check whether the user already has a record, for example if the user has subscribed to this content provider or another content provider previously, and if so will record that the user is authorizing this server to send alerts to their mobile device 810.

If the user is not registered, a record is created for this user in the user register data base 870 and the user information added.

The event alert and delivery system 830 then performs a registration verification or confirmation process to verify that that the user is the real user and confirm they are authorizing or opting in to allow the content provider server 840 to send alerts and that they agree to the terms and service of this service. This process is started by the gateway server 830 sending an SMS message 804 to an SMS server 820 for forwarding 805 to the user's mobile device 810. The SMS server forwards the SMS message 805 to the mobile device 810 and when the mobile device 810 receives the SMS message it will display the message text 880 to the user 806.

The user is requested to reply 807 to this message to verify that they are the real mobile device owner. The user's reply 807 to the SMS message is sent 808 to the SMS server 820 and returned 809 back to the event alert and delivery gateway server 830 and recorded 803 in the user register data base system 870. Once the OPT-IN from the user mobile device 810 has been recorded in the user register data base 870 a registration verification return or response 812 will be sent to the original alert server 840.

If the user is a new user and therefore has not previously loaded event alert and delivery processing applications on their mobile device 810 then another SMS message with an automatic signal to start the downloading and installation of the Application will be issued by either the event alert and delivery gateway server 830 or the original authorizing server 840. The application can be adapted to automatically download and install on the user's device 810. Once the application is installed, the user's device is adapted for receiving and alert messages and acquiring and displaying content as described above.

The system may be used with various types of content providers and units/systems that generate an event. For example, the alert system can operate with a web site, such as MySpace.com, wherein the event is any modification of the blog of the Myspace user so that the alert system is able to notify the user of the change and optionally render the blog of the user with the changes shown. As another example, the alert system may be used with a hotel chain reservation system wherein the event is a user reservation at a hotel that causes the reservation confirmation, map around the hotel, directions to the hotel, etc. to be delivered to the user. The event message generator 120 itself could be the source of the event such as a timer that has been set to create a meeting notice event or a calendar event such as a birthday.

Although in the embodiment described above uses an SMS Gateway Server which interacts with the SMS Server to queue the event alert message for delivery to the user's device, other messaging systems or methods are envisaged within scope. For example, several communications carriers have developed their own in-house SMS servers and other carriers use outside services that consolidate SMS Servers from many different carriers. Alternative messaging systems to SMS may also be used. The system can utilize any messaging technology which positively delivers the message to the device on the demand of the message sender, as opposed to a system which relies on messages being polled or fetched periodically by the mobile device. For example, a voice call using a special phone number that the application running on the mobile device can see using caller ID and therefore instead of causing the device to ring the application can send a reply to the call setup process back to the originator as the device is busy, offline, or any status that the system may decide to use as a signaling method, and then start a process to fetch, from a known location, the pointers to content that is to be fetched and delivered to the users device. Other signaling methods using alerts such as cellular phone switching control signals such as an incoming call, test control call, or a polling control signals may also be used if the API is allowed to access these types of signals. MMS or other messaging systems an enhanced messaging service (EMS), a premium short messaging service (PSMS) message, and a Message Peer to Peer protocol (SMPP) message service can also be used.

Using a messaging system such as SMS utilizes the fact that messages are forwarded to a user via any number of networks operated by different carriers based on the destination address, the messaging is not limited to a particular network carrier. Where the system uses a number of message servers or gateways, the system can be provided with functionality to choose the lowest cost routing for event messages based on information from the user profile such as the user's location or mobile phone network carrier. As the event messages are all sent from the system the content provider is relieved of the need to determine which is the most cost effective message routing or least expensive manner to alert its subscribers when events occur. Further, by using cellular or GPS roaming functions the gateway system can find local event servers or pointer list servers from which the content location data can be fetched to minimize or avoid long distance or roaming access charges.

Embodiments of the system can provide a decentralized network of event servers and utilize large scale access deals with a number of carriers or user services of aggregators of messaging services to provide an event alert and delivery service which is carrier independent to the user. For example, currently carriers lock applications, such as applications running through Internet web sites, to access locations (walled gardens) to force the application to deal exclusively with them to use the SMS servers. Aggregators which access a number of SMS servers operated by different carriers can be used to overcome this problem. Further, utilizing the ability for the mobile devices initiate the connection to the content servers further enables carrier restrictions to be avoided from the content providers' perspective. This allows the system to send alerts to user phones by using standard open interfaces.

Billing for the event alert service can take place in a number of ways, for example the SMS Gateway Server 222 may also cause a billing event for the message service as used today in systems like Simplewire, M-Blox and Verisign where SMS and premium SMS (PSMS) services cause each SMS message that is sent to be billed for example 10 cents, for each message sent to the user, the costs for the SMS messages appear on the user's account, such as their mobile phone bill. The SMS Gateway Server 222 may also in another embodiment verify that a monthly fee, for example a monthly fee of 10 dollars for 1000 messages or 20 dollars for unlimited messages is billed to the user, such an account may be maintained and billed by the event system independent of any network carrier subscription. Alternatively an event alert service may be provided free or at a minimal upfront cost to the users by the event service provider obtaining revenue from the content providers directly or via advertising appended to event messages or content. Further, the Content provider may as part of their business pay for the content delivery and as part of the content and may attach advertising that they can use to generate revenue.

The system enables charging or billing the user for the data content or access to the data content at any point along the process steps. The user can be charged when the messages is sent and the charge can consist of the cost of the message transmission, the cost of preparing the content, the cost of storing the content on the content provider server, the cost of leaving the content on the content provider server for a period of time. The user can also be charged to access the content that the message points to. An example would be that the message indicates that a basket ball game score has changed but the user does not have time to get the details of who scored the basket and the background on the player that scored that basket. Access to the details may cause other charges to be billed against the users account.

An advantage of the alert system/message push system is that the system can be used to push various pieces of information, such as stocks, news, sports, game events, marketing info, specials (2 for 1), airplane schedule, order status, school events, meeting schedules and other information that a user would like to receive an alert about. The communications computing device may render the retrieved information in various formats, such as XML, WAP, Data (text, graphics, tones, audio), music, browsers.

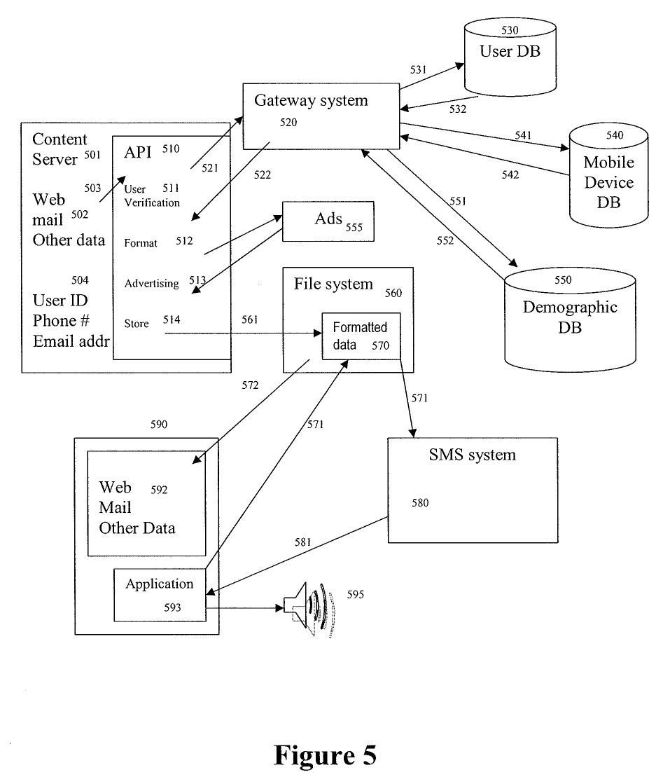

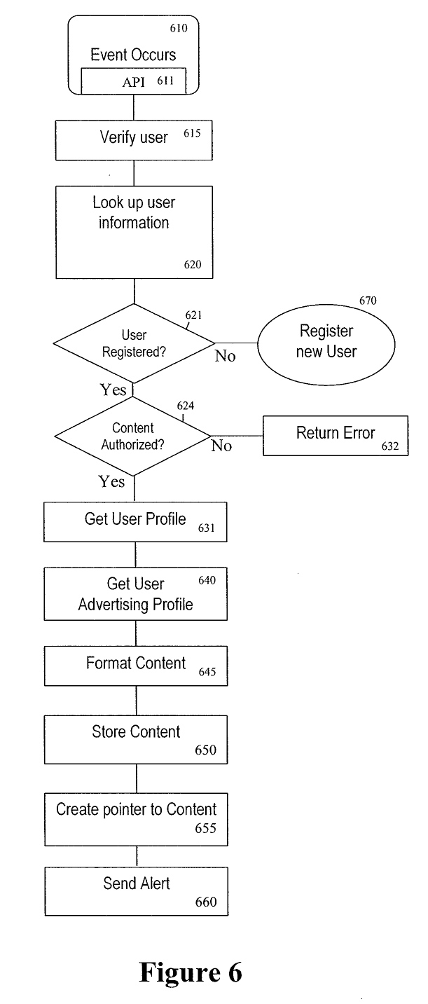

FIG. 5 illustrates one possible implementation of an alert and delivery system of an embodiment. The alert process, as illustrated in FIG. 6, starts by an event occurring 610 at the Content Server 501. The event may in the form of a Content 502 update. For example an update to a web site, an updated RSS feed, an e-mail arrival, updated to a blog on a social network web page or any other data that may have been updated or changed.

When the Content 502 is changed or updated the Content server 501 calls an API 510 611 or other similar type of link 503 between two pieces of software used in programming. The link 503 is used to pass the Content 502 for display on the user's communication computing device 590 and a user identifier 504, which may consist of a phone number, a userid, an e-mail address or other User type of identification, to the API program 510.

When the API program 510 receives this data one of its first steps 615 is to verify 511 that the user is a valid and functional user that has been registered in the system. This API will also check that the user has authorized the content server 501 to send content to the user 590. The API program 510 communicates with a gateway system 520 to perform this verification. The gateway system may be part of the API 510 software program or a separate program running on the same server or on another server connected using any know communication method.

The verification call or message 521 contains the user identification 504 and may, if necessary, contain content server 501 identification information. The Gateway server system processes this information in several steps as outlined below. The gateway server indexes or looks up 531 620 the user identification in a user register in data base system 530. The gateway server may also translate this user ID into another form that can be used to verify the user, such as a yahoo userid or a hot mail email account or a encoded user number like a tax identifier, social security number or other user special identification number. From this information it is determined whether the user is registered in the system to receive alert messages 621. If a user is not registered then the user can be registered as a new user 670. If the user is registered, the next step 624 is to check whether the user has authorized the content server 501 to send event alerts, if the content server is not authorized an error will be returned 632.

The process of verifying the user 621 determines whether the user has the receiving software application 593 installed and whether the user has authorized 624 the content server 501 to send this content 502 to the user. Many other items can also be checked and verified, such as whether the user has paid their monthly billing or how this Alert transaction billing process will occur. Their may also be a billing function that will cause the Alert system to bill the user as a function of receiving the Alert or as a function of the content being delivered to the users.

If the verification information is returned 532 indicating the content 502 is authorized then additional step may be taken. For example, the user's mobile device database 540 can be accessed to obtain information or profiles 631 about the user's mobile device 590. This mobile device information access 541 can be used to call a mobile device data base 540 from the gateway server 520.

The mobile device data base 540 can be updated by the Content server 501, for example to update the database 540 when a new subscriber is added to the content server, by the user by accessing a web page that gives them access to their user profile and their mobile device profile record, or by the Alert application 593 as a function of its normal operation to maintain and update the Mobile device data base 540. The Mobile device 590 may also update device information database 540 if the device is reconfigured or internal parameters are changed. The data about the mobile device is accessed and returned 542 to the gateway system 520 then this information is retuned 522 to the API 510 software to be used for other steps like data formatting 512.

The Mobile Device 590 may also update other data base systems with other information such as its location, if the device is Global positioning systems (GPS) enabled, which mobile carrier it is currently using, or which cellular base station the device is currently connected to for accessing communication network infrastructure.

As part of the gateway 520 processing user data 532 and device data 542 can be retrieved to allow a user profile or environment to be created. This user profiling can be used to provide other software functions in the system to appropriately format 512 and size the content data or to limit certain content functions before the data is sent or fetched by the user device 590.

The Gateway 520 system can also perform other processing, for example demographic 550 and past content access information may also be available to help format or select the kind of content that will be sent to the user.

Advertising can be part of the original content that is being sent to the user or as part of the API function additional content or advertising content can be fetched 555 and added to the original Alert triggered content 501. Using Demographic or past content type profiled information can be used to select which of different types of add on content or advertising 555 to add for a particular user. For example, the user's device profile can be fetched 631 then an advertising profile say based on demographic information can be fetched 640 for the user. Advertising information to be appended to the alert message can then be selected based on the user advertising profile. This add on content may be added either before the content is formatted 512 for the device or preformatted content or advertising can be concatenated to the content before or as part of content delivery to the mobile device. For example, adverting data to concatenate to the data content may be addressed using a pointer to advertising data cashed on another server or different area in the content server.

Once the User information and other optional information has been gathered 532, 542, 552 and returned to the API 522 formatting of the content 645 can be done to enable custom formatted data 512 to be delivered to the mobile device 590. This data format can be an existing format or a new format.

The formatted data 512 and any advertising 513 can be stored 514 650 as a formatted data file 570 in a file system 560 or data base system located either on the content server or an external file server. The content data can be stored anywhere in a network as long as the mobile device can access it. A pointer 655 to the stored content for the user can be returned for enabling the mobile device to access the stored content data file 570.

Once the data is stored 561 in a storage area 560 an Alert message 571 or control signal 571 is sent 660 to a Messaging system such as SMS server 580 for forwarding to the user's mobile device.

The SMS server sends alert message 581 to the mobile device 590. When the mobile device receives the Alert message, an application 593 that has been registered to receive the alert 581 will be started or the application may be running because of a prior alert that it is still handling. Once this application software has received the message 581 then the application 593 will connect to a predefined file server 560 to retrieve a list of formatted pointers 570. The location to fetch the pointer or list of pointers can be stored in the user device memory, for example setup when the application is installed as part of the installation parameters or it can be retrieved as part of an application initialization process. The location of the pointer list can be fetched from the gateway server or other parts of the system that are predefined as being valid, secure and part of the Alert system. Once setup this list pointer will be used. A number of gateway server or pointer list server locations may be stored in the mobile device memory, for example to enable roaming between servers when the user changes location. If an attempt to retrieve a list pointer fails the application may go back to the original setup processes to connect to another pointer server.

The list of pointers will allow the application 593 to access other formatted data 512, 513 from the content provider's server and load this data on to the mobile device. Once the data is received the mobile device software application 593 can prepare and display the content 592 on the mobile device screen 592 and Alerts 595 the user that new content is available for view.

What is claimed is:

1. A system comprising:
a validator adapted to receive information regarding an event occurrence from a source and validate whether the source of the event is an authorized content provider; and
an event message generator configured to generate an event alert message to be delivered to a user's communication computing device via a communication network that will enable a communication session to be opened by the communication computing device between the communication computing device and an authorized content provider for acquisition of content data associated with the validated event via the communication network.

2. A system as claimed in claim 1 wherein the information regarding an event occurrence includes a user identifier and the validator determines whether the user has authorized the content provider for the event.

3. A system as claimed in claim 2 further comprising a user register wherein for each user details are recorded for content providers or events which the user has registered to receive content data and are used for validation.

4. A system as claimed in claim 3, wherein the user register further records user device profile information for each user.

5. A system as claimed in claim 4 wherein once and event is validated the user profile is provided to the authorized content provider.

6. A system as claimed in claim 1 wherein the information regarding the event occurrence includes authorization information verifiable by the validator.

7. A system as claimed in claim 6, wherein the authorization information is a user specific authorization code.

8. A system as claimed in claim 7, wherein the authorization code is temporary and expires after a specified time period or after the completion of data acquisition from the content source.

9. A system as claimed in claim 1 further comprising a content source information server, and on reception of an event alert message the user's mobile device is adapted to connect to the content source information server to obtain content source location information enabling the user's device to open the communication session between the user's device and the authorized content source provider to acquire the content data.

10. A system as claimed in claim 9 wherein the content source location information for each authorized content provider includes the content server address of the authorized content provider server and a pointer to the validated event content data for downloading to the user.

11. A system as claimed in claim 1 wherein the communication session is opened between the communication computing device and each content provider and the content from each content provider acquired in response to a single action by the user in response to the event alert.

12. A system as claimed in claim 1 wherein each authorized content provider is adapted to automatically send information regarding an event occurrence to the validator when an event occurs.

13. A system as claimed in claim 12 wherein the information regarding the event occurrence includes a subscriber identifier, wherein the subscriber identifier includes any one or more of: a subscriber's communication computing device calling number, a subscriber's communication computing device equipment identification number, a subscriber's e-mail address, a subscriber's name, a subscriber's alias, an International Mobile Subscriber Identifier, an International Mobile Equipment Identifier, and a subscriber's subscription identifier.

14. A system as claimed in claim 13 wherein the system provides an application to each content provider for generating and forwarding the event occurrence information to the validator.

15. A system as claimed in claim 1 further comprising an application for adapting a subscriber's communication computing device to open a communication session with a content provider in response to event alert and content source information messages.

16. A system as claimed in claim 1 wherein the communication session uses GPRS protocols.

17. A system as claimed in claim 1 further comprising a formatter adapted to convert the content data from a content provider format to a format adapted for display on the communication computing device.

18. A system as claimed in claim 17 wherein the formatter is provided as an application executed by the content provider adapted to format and store content data in the content provider's storage facility for delivery to a user's communication computing device when an event occurs.

19. A system as claimed in claim 18 wherein the formatter application is provided to the content provider when the content provider registers with the system.

20. A method comprising:
receiving information regarding occurrence of an event;
validating whether or not the event is an event from an authorized content source for a user;
generating an event alert message for a validated event;
delivering the event alert messages to a communication computing device of the user; and
opening a communication session between the communication computing device and the content source for the acquisition of content data associated with the validated event based on the event alert message.

21. A method as claimed in claim 20 further comprising fetching content source location information for a validated event by the communication computing device from a content source information server.

22. A method as claimed in claim 20 further comprising receiving authorization from the user authorizing the content source.

23. A system comprising:
means for receiving information regarding occurrence of an event;
means for validating whether or not the event is an event from an authorized content source for a user;
means for generating an event alert message for a validated event;
means for delivering the event alert messages to a communication computing device of the user; and
means for opening a communication session between the communication computing device and the content source for the acquisition of content data associated with the validated event based on the event alert message.

24. A computer readable medium comprising programming instructions that upon executing cause a machine to:
receive information regarding occurrence of an event;
validate whether or not the event is an event from an authorized source for a user;
generate an event alert message for a validated event;
deliver the event alert messages to a communication computing device of the user; and
open a communication session between the communication computing device and the content source for the acquisition of content data associated with the validated event based on the event alert message.

25. A method, comprising:
receiving a wireless messaging service message via a network;
in response to receiving the wireless messaging service message, retrieving via the network at least a data structure from a predesignated location, the data structure identifying at least one electronic device; and
retrieving data from the identified electronic device.

26. The method of claim 25, wherein the messaging service message comprises one of a short messaging service (SMS) message, a multimedia message service (MMS) message an enhanced messaging service (EMS) message, a premium short messaging service (PSMS) message, and a Message Peer to Peer protocol (SMPP) message.

27. The method of claim 25, wherein the messaging service message comprises external short message entities interface information.

28. A system, comprising:
means for receiving a wireless messaging service message via a network;
in response to receiving the wireless messaging service message, means for retrieving via the network at least a data structure from a predesignated location, the data structure identifying at least one electronic device; and
means for retrieving data from the identified electronic device.

29. A system, comprising:
a communication computing device configured to receiving a wireless messaging service message via a network, and in response to receiving the wireless messaging service message, retrieve via the network at least a data structure from a predesignated location, the data structure identifying at least one electronic device, and retrieve data from the identified electronic device.

30. A computer readable medium comprising programming instructions that upon executing cause a machine to:
receive a wireless messaging service message via a network;
in response to receiving the wireless messaging service message, retrieve via the network at least a data structure from a predesignated location, the data structure identifying at least one electronic device; and
retrieve data from the identified electronic device.

31. A method comprising:
receiving a messaging service control message via a network; and
in response to receiving the messaging service control message, retrieving via the network at least a data structure from a predesignated location.

32. The method of claim 31, wherein the messaging service control message identifies a port of an electronic device and wherein the electronic device activates a predesignated application in response to the messaging service control message message being sent to the identified port.

33. The method of claim 31, additionally wherein the data structure identifies at least one electronic device.

34. The method claim 33, additionally comprising retrieving data located at the identified electronic device.

35. The method of claim 31, additionally wherein the data structure identifies a universal resource locator.

36. The method of claim 31, wherein the messaging service control message identifies a phone number of an electronic device receiving the messaging service control message.

37. An electronic device configured to:
receive a messaging service control message via a network; and
in response to receiving the messaging service control message, retrieve via the network at least a data structure from a predesignated location.

38. An electronic device comprising:
means for receiving a messaging service control message via a network; and
in response to receiving the messaging service control message, means for retrieving via the network at least a data structure from a predesignated location.

39. A computer readable medium comprising programming instructions that upon executing cause a machine to:
receive a messaging service control message via a network; and
in response to receiving the messaging service control message, retrieve via the network at least a data structure from a predesignated location.
